(19) United States
(12) Patent Application Publication
(10) Pub. No.: US 2022/0305442 A1
(43) Pub. Date: Sep. 29, 2022

(54) HEATED MEMBRANE/MODULE FOR THERMALLY-DRIVEN MEMBRANE DISTILLATION SYSTEMS

(71) Applicant: KING ABDULLAH UNIVERSITY OF SCIENCE AND TECHNOLOGY, Thuwal (SA)

(72) Inventors: Mustakeem MUSTAKEEM, Thuwal (SA); Adnan QAMAR, Thuwal (SA); Alla ALPATOVA, Thuwal (SA); Noreddine GHAFFOUR, Thuwal (SA)

(21) Appl. No.: 17/632,927

(22) PCT Filed: Aug. 4, 2020
(86) PCT No.: PCT/IB2020/057365

§ 371 Date: Feb. 4, 2022

Related U.S. Application Data
(60) Provisional application No. 62/883,744, filed on Aug. 7, 2019.

(51) Int. Cl. B01D 61/36; B01D 67/00; C02F 1/00; C02F 1/44

(52) U.S. Cl. CPC B01D 61/366; B01D 61/364; B01D 67/0088; C02F 1/008; C02F 1/447; B01D 2313/22; B01D 2313/365; B01D 2313/18; C02F 2103/08

(57) ABSTRACT

A membrane for membrane distillation processing includes a heating element configured to generate heat when an electrical current is applied to the heating element; a polymeric matrix having pores that allow a vapor to pass through, but not a liquid; and electrical contacts electrically connected to the heating element. The entire heating element is covered by an insulating material to prevent the heating element to directly interact with the liquid processed by the membrane.

### CROSS-REFERENCE TO RELATED APPLICATIONS

This application claims priority to U.S. Provisional Patent Application No. 62/883,744, filed on Aug. 7, 2019, entitled “JOULE HEATING ENERGIZED MEMBRANE/MODULE FOR THERMALLY-DRIVEN EFFICIENT MEMBRANE DISTILLATION SYSTEMS,” the disclosure of which is incorporated herein by reference in its entirety.

### BACKGROUND

### Technical Field

Embodiments of the subject matter disclosed herein generally relate to a membrane distillation (MD) system that circumvents conventional desalination limitations when treating highly-saline brines, and more particularly, to an MD system that locally heats the feed and membrane for reducing the energy used to distillate the water.

### Discussion of the Background

Clean water is essential for human survival, and it is estimated that its global demand will escalate by 30% in the next decades. Therefore, intensive efforts have been put forth to transform unconventional sources like sea and brine waters into freshwater, by utilizing a range of desalination technologies. Water desalination has manifested itself as a sustainable and reliable means of freshwater production not only in arid and semi-arid regions of the Middle East and Northern Africa (MENA), but also in coastal countries with moderate weather conditions. Consequently, the water distillation industry has grown exponentially in recent decades, with a cumulative annual growth rate of about 4.5%, currently employing more than 18,000 desalination plants around the world.

However, the high energy consumption associated with the desalination processes, coupled with the depleting of the global energy resources, have increased the pressure on reducing the energy requirement of the conventional desalination technologies through further improvements and development of novel energy efficient processes.

Membrane distillation has emerged as one of the advanced desalination techniques, having numerous advantages over the conventional membrane-based (seawater reverse osmosis, SWRO) and thermal-based (multi-stage flash, MSF, and multi-effect distillation, MED) desalination processes. Its moderate operating conditions make it a promising economical and energy saving desalination approach. Contrary to the SWRO, the MD process does not require high-grade electrical energy for its operation and works in lower feed water temperature range compared to the MSF process, while producing high-quality freshwater. The MD process, which essentially uses a membrane that allows the water vapor to pass through, but not the fluid water, also has an advantage in treating highly-saline feed waters facilitating high-salt rejection and low fouling propensity as compared to other well-established desalination technologies.

However, despite the high-potential of the MD process to circumvent the problems associated with the conventional desalination technologies, its energy consumption remains high due to the inherent heat loss manifested during system operation. In this regard, a conventional MD system 100, which is illustrated in FIG. 1, includes a permeate part 110 and a feed part 140. The permeate part 110 includes a permeate tank 112 that holds the permeate fluid 114. The permeate fluid 114 is collected through a piping system 116 from a permeate compartment 120. A pump 118 may be connected to the piping system 116 for moving the permeate fluid 114 through the permeate part 110. Various measurement units, for example, a flowmeter 122, a conductivity meter 124, etc. may be attached to the piping system 116 for measuring associated parameters of the permeate fluid 114. A chiller 124 may also be connected to the permeate tank 112 for cooling down the permeate fluid 114. One or more temperature sensors 126 may be distributed along the piping system 116 for monitoring a temperature of the permeate fluid 114 through the permeate part 110.

The feed part 140 includes a feed tank 142 that stores the feed fluid 144, e.g., seawater or a brine. A high-energy heater 146 may be attached to the feed tank 142 for heating up the feed fluid 144. The feed fluid 144 is moved through a piping system 148, due to a pump 149, to a feed compartment 150. The feed compartment 150 together with the permeate compartment 120 sandwich a membrane 160, through which the water vapors are allowed to pass, from the feed compartment toward the permeate compartment, but not the feed fluid. The feed part 140 includes one or more sensors, for example, a flowmeter 152, or temperature sensors 154. A data acquisition system 170, for example, a computing system, may be connected to one or more of these elements for controlling them.

As the bulk feed fluid 144 is heated externally of the feed compartment 150, where the distillation process starts, by the heater 146, it causes up to 50% of conduction heat losses due to the heat released to the atmosphere. Furthermore, when the feed fluid 144 enters feed compartment 150, its bulk temperature Tb is higher compared to the membrane surface temperature Ts, as illustrated in FIG. 2, because of the convective energy losses and latent heat release during the liquid to gas phase transition. The difference between the feed fluid temperature at the membrane surface Ts and the bulk temperature Tb is known as the temperature polarization (TP). The TP can be as high as 10° C. in a traditional MD module, leading to decreased heat and mass transport rates across the membrane 160. Consequently, the MD energy efficiency decreases due to the limitations of the thermal boundary layer at the membrane-liquid interface. Several studies have mitigated the TP by using turbulence creators such as spacers; however, this approach creates additional pressure on the energy requirement of the system.

Taking into consideration that the TP and the conduction heat loss is an inherent process deficiency which cannot be fully mitigated, it is highly desirable to seek alternative approaches to alleviate heat losses and achieve sustainable MD performance. Thus, there is a need for a new system that is capable of reducing the TP and the convective energy losses without increasing the energy that is spent on the system.

### BRIEF SUMMARY OF THE INVENTION

According to an embodiment, there is a membrane for membrane distillation processing. The membrane includes a heating element configured to generate heat when an electrical current is applied to the heating element, a polymeric matrix having pores that allow a vapor to pass through, but not a liquid, and electrical contacts electrically connected to the heating element. The entire heating element is covered by an insulating material to prevent the heating element to directly interact with the liquid processed by the membrane.

According to another embodiment, there is a membrane distillation (MD) system for distillation, and the MD system includes an MD module configured to distillate a feed fluid, a heating element provided inside the MD module and configured to heat the feed fluid by Joule effect, a power source connected to the heating layer for providing an electrical current to the heating layer, a feed tank configured to hold the feed fluid and to provide the feed fluid to the MD module, and a permeate tank configured to hold a permeate fluid and to collect the permeate fluid from the MD module. There is no external heater for heating the feed fluid while inside the feed tank.

According to still another embodiment, there is a method for producing distilled water from a feed fluid. The method includes feeding the feed fluid from a feed tank to a feed compartment; heating by Joule effect the feed fluid with a heating element only inside the feed compartment; distilling the feed fluid with a membrane placed away from the heating element so that vapors passing through the membrane collect in a permeate compartment as a permeate fluid; collecting the permeate fluid at a permeate compartment; and discharging waste from the feed compartment, into a waste tank, which is not fluidly connected to the feed tank so that the waste cannot return back to the feed tank. There is no external heater for heating the feed fluid while inside the feed tank.

### BRIEF DESCRIPTION OF THE DRAWINGS

Fora more complete understanding of the present invention, reference is now made to the following descriptions taken in conjunction with the accompanying drawings, in which:

FIG. 1 is a schematic diagram of an MD system that uses an external heater for heating a feed fluid inside a feed tank, prior to delivering the feed fluid to the MD module;

FIG. 2 illustrates an MD module having a membrane sandwiched between a feed compartment and a permeate compartment;

FIG. 3A illustrates a Joule heating energized membrane that includes a heating element fully enclosed in a polymeric layer;

FIG. 3B illustrates a Joule heating energized membrane that includes a heating element having one side covered by a polymeric layer and another side covered with a coating;

FIG. 4A shows a wire mesh that serves as the heating element and FIG. 4B shows the wire mesh coated with the polymeric layer to form the membrane;

FIGS. 5A to 5D show various possible shapes of the wire mesh to be used in the membrane;

FIG. 6 shows another Joule heating energized membrane in which the heating element is provided outside the membrane, within the feed compartment;

FIG. 7A shows a top view of an MD module having a heating element provided at a given distance from the membrane and FIG. 7B shows a cross-sectional view of the same MD module;

FIG. 8 shows an MD system that uses the MD module shown in FIGS. 7A and 7B and the MD system is configured to allow the feed flow to be recirculated through the feed part of the system;

FIG. 9A shows an MD system that uses the MD module shown in FIGS. 7A and 7B and a membrane as illustrated in FIG. 3A or 3B;

FIG. 9B shows an MD system that uses only the membrane illustrated in FIG. 3A or 3B;

FIG. 10 shows an MD system that uses the MD module shown in FIGS. 7A and 7B and the MD system is configured to not allow the feed flow to be recirculated through the feed part of the system;

FIGS. 11A to 11D illustrate the permeate flux and the temperature associated with the configurations presented in FIGS. 1, 8, and 10;

FIG. 12 shows the mass of the permeate obtained with the systems illustrated in FIGS. 1, 8, and 10;

FIG. 13 shows the permeate flux obtained with the systems illustrated in FIGS. 1, 8, and 10;

FIGS. 14A and 14B show the heat distribution percentage and the gain output ratio of the systems illustrated in FIGS. 1, 8, and 10;

FIG. 15 illustrates the specific energy consumption of the systems illustrated in FIGS. 1, 8, and 10; and

FIG. 16 is a flow chart of a method for using the systems illustrated in FIGS. 8 and 10 for water desalinization.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a single heat energized membrane disposed in an MD module. However, the embodiments to be discussed next are not limited to a single membrane, but may be applied to systems having plural heat energized membranes.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel MD module is introduced to alleviate the TP and sustain the MD net driving force by tailoring the membrane's surface in a way that it serves as a heated substrate to the feed flow by enhancing the evaporation process at a pore entrance. This will enable a direct energy supply to the vapor/liquid interface at the membrane surface and compensate for heat losses due to the TP. The associated mass transfer across the membrane is expected to significantly improve, leading to higher permeate fluxes. Moreover, the targeted heating of the feed flow which is in contact with the membrane's surface, requires less energy input as compared to the traditional configuration in which the heat is provided by the external heater to maintain a stable temperature of the entire bulk feed flow.

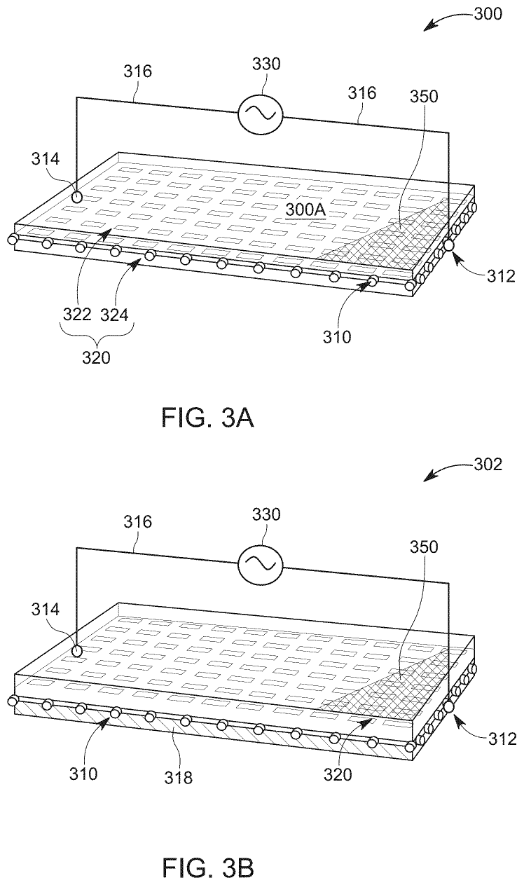

More specifically, according to an embodiment, as shown in FIG. 3A, a new type of porous polymeric membrane 300 (called herein an “energized membrane”) is manufactured by incorporating a Joule heating layer 310 inside the polymeric matrix 320 so that the membrane's surface 300A can provide localized feed heating when connected to a source 330 of electrical power. While FIG. 3A shows a first implementation 300 of this membrane, in which the polymeric matrix 320 includes two layers 322 and 324 that sandwich the heating layer 310, FIG. 3B shows a second implementation of the membrane 302 where the polymeric matrix 320 is manufactured as a single layer, which is supported by the heating layer 310.

The heating layer 310 may include any one or a combination of a metal, alloy wire, and wireframe mesh with a high-resistivity and a low thermal coefficient of expansion (e.g., Ni—Cr alloy, Nichrome). The heating layer 310 is fully encapsulated into one or more insulator materials for preventing the feed flow, which is typically sea water, to chemically interact with the metallic material, to prevent energy and material waste through electrolysis. In the embodiment of FIG. 3A, the heating layer 310 is implemented as a mesh (or any design of heating element) that is fully encapsulated by the polymeric layers 322 and 324. The polymeric matrix 320 may be made of hydrophobic organic or inorganics materials (e.g., polytetrafluoroethylene (PTFE), polyvinylidene fluoride (PVDF), polypropylene (PP)). Two electrical contacts 312 and 314 are made at the ends of the heating layer 310 and they are connected to leads 316, which are in turn connected to the power source 330.

In the embodiment illustrated in FIG. 3B, one side of the heating layer 310 is fully covered by the polymeric matrix 320, while the other side is fully covered with a coating 318 (for example, an insulating material different from the polymeric matrix 320) for sealing the heating layer 310 from the ambient, so that the liquid (feed fluid) processed by the membrane does not enter in direct contact with the heating layer. The membranes 300 and 302 shown in FIGS. 3A and 3B can further include a coating 350 on one side of the polymeric matrix 320, where the coating may include nanoparticles or/and nanosheets with dual conducive/photo-thermal properties (e.g., ternary metal carbides). The coating 350 is shown in FIGS. 3A and 3B to only partially cover a surface (the one exposed to the feed flow) of the polymeric matrix 320, but those skilled in the art would understand that any fraction (up to one) of the external surface of the polymeric matrix can be covered with the coating 350. The coating 350 may be used during the day, when the sun is strong, to transform the solar energy into heat, to directly heat the feed flow at the surface of the membrane. The same coating 350 may be made with conducting particles, so that an electrical current from the power source 330 may be driven through the coating to heat the feed flow when the solar energy is not available. It is anticipated that an alternation of the MD energy source (e.g., using photo-thermal heating during the day time operations and Joule heating during the night time operations) will allow to overcome the limitation of the solar-based MD process (when the sun is not present) as the same membrane can be switched to complete Joule heating mode during periods of low solar intensity. As such, the MD process will be intensified.

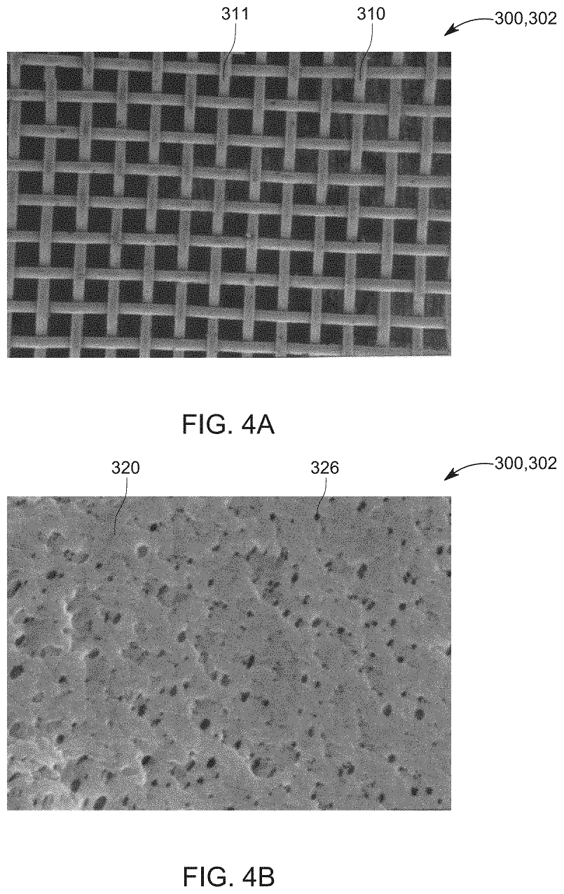

If the metal/alloy wire/wireframe mesh 310 is used as a support layer for the polymeric matrix 320, as shown in FIG. 3B, the membrane is directly casted on a surface of the metal/alloy wire/wireframe mesh so that the polymeric layer separates the water vapor from the feed fluid while the underlying Joule heating layer supplies heating to the feed flow, which is flown over the membrane surface. The Joule heating layer will also provide mechanical support to avoid the membrane's stretching and deformation. In this regard, FIG. 4A shows the heating layer 310, being formed as a mesh of metal wires 311 and FIG. 4B shows the polymeric material being sprayed over the mesh of metal wires 311 to form the polymeric layer 320. Pores 326 are present in the polymeric layer 320 and the water vapors would be able to pass through the membrane 300, 302 through these pores. If the membrane 300 is to be made, then the metal/alloy wire/wireframe mesh 310 is embedded between the two layers of polymer 322 and 324 as shown in FIG. 3A. In this case, the polymeric layers 322 and 324 may be sprayed on both sides of the Joule heating media 310 to obtain the sandwiched structure.

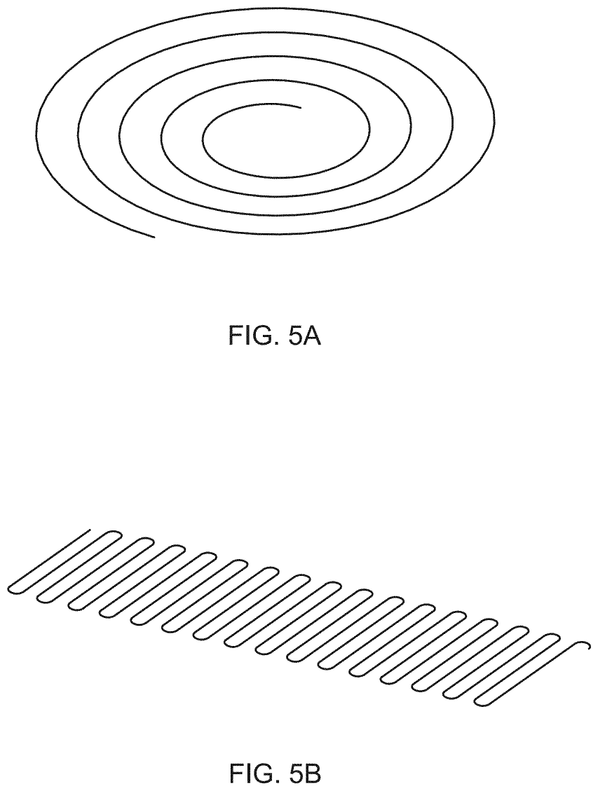

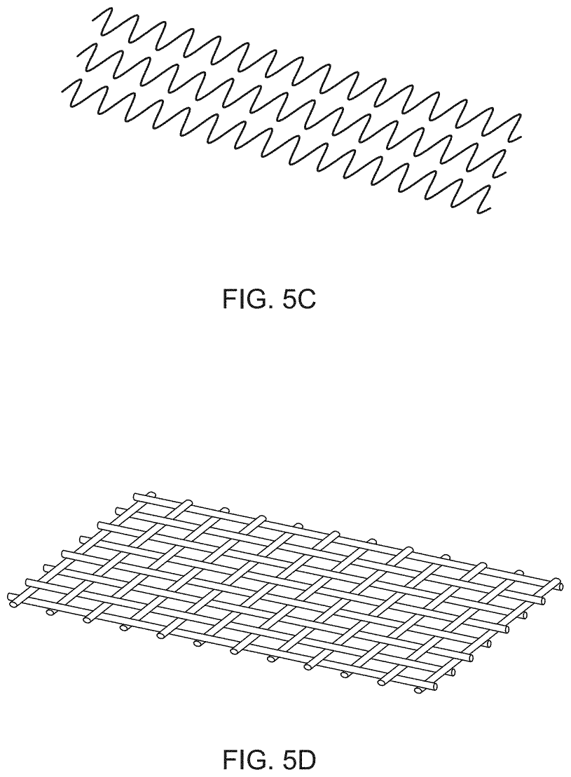

The metal/alloy wire 311 can be shaped in various designs, e.g., spiral as shown in FIG. 5A, rectangular compression as shown in FIG. 5B, wavy as shown in FIG. 5C, or as a mesh with different sizes as shown in FIG. 5D. The material, design, thickness and any other inherit property of metal/alloy wire/wireframe may vary depending on the heat necessary to be transferred to the feed flow and the overall size of the MD module. In one embodiment, the wire used to make the mesh is covered with an insulator, other than the polymeric matrix 320 or the additional insulator 318 so that the metallic part is prevented from directly touching the feed flow.

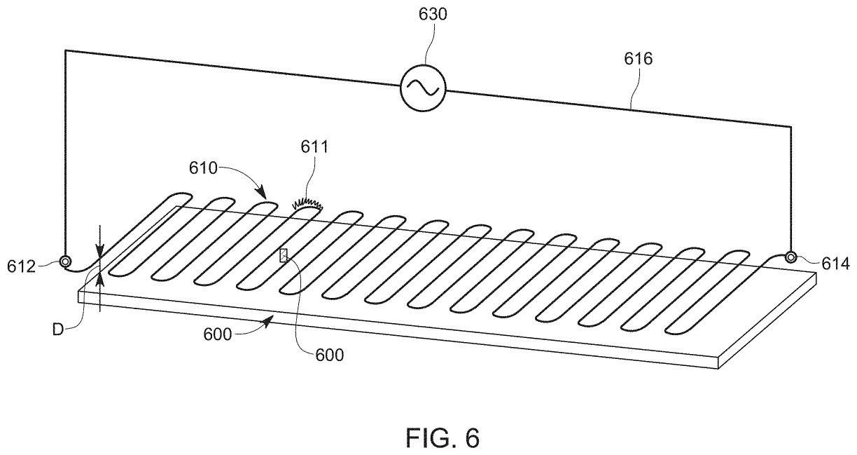

According to another embodiment, as illustrated in FIG. 6, to heat the feed flow directly at the surface of the membrane, the heating layer is disposed outside of the membrane, and not inside of the membrane as shown in the embodiments of FIGS. 3A and 3B. FIG. 6 shows the membrane 600 being separated by a given non-zero distance D from the heating layer 610. The heating layers 610 is connected with leads 616 to the power source 630 and the leads 616 are attached at connecting points 612 and 614 to the ends of the heating layer 610. The membrane 600 and the heating layer 610 may be made of similar materials as those in the membranes 300, 302 discussed above. In one embodiment, the heating layer 610 is attached to a wall of the MD module (not shown) to achieve the desired distance D. In another embodiment, separators 640 (only one shown in the figure for simplicity) may be installed between the membrane 600 and the heating layer 610 to maintain the heating layer 610 at the desired distance D from the surface of the membrane. In one application, the distance D is in the range of 1 to 20 mm, with a more desired range of 5 to 15 mm, and with a preferred range of 8 to 12 mm.

When the heating layer 610 is activated, it is expected to not only heat the feed flow near the surface of the membrane, but also to generate turbulence, in the feed channel, to enhance the feed channel hydrodynamics. The heating layer 610 may include one or more conductive materials with a high-resistivity and low-thermal coefficient of expansion. To avoid water electrolysis arising from the current passing through the heating layer while heating the feed flow, the heating layer 610 may be coated with a MgO/Al₂O₃ mixture to provide an electrical insulation 611 (schematically illustrated in FIG. 6 for a small portion of the heater, for simplicity) having thermal conduction properties.

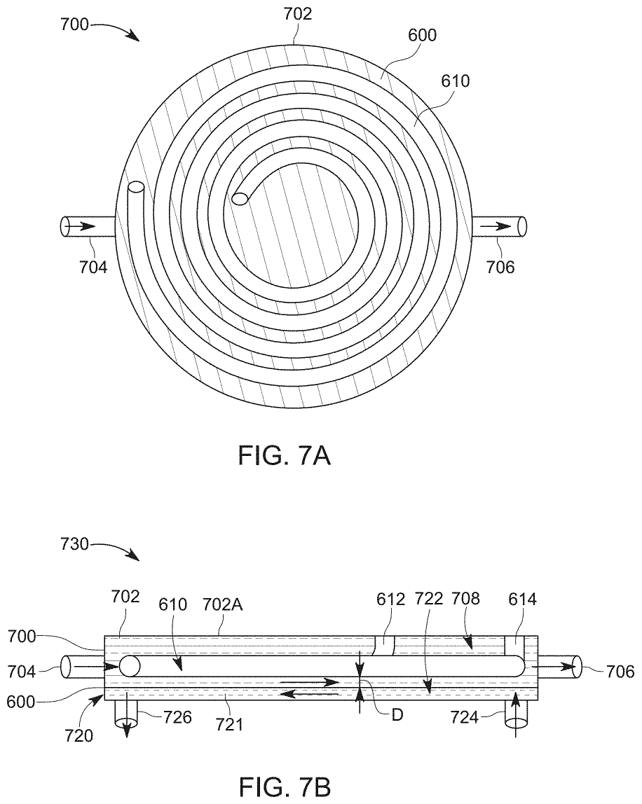

The membrane 600 is shown in FIGS. 7A and 7B being placed next to a feed compartment 700, that includes the heating layer 610. The feed compartment 700 has a housing 702, for example, made of stainless steel, that houses the heating layer 610. FIG. 7A shows a top view of the feed compartment 700 while FIG. 7B shows a cross-section view of the MD module 730 which includes a permeate compartment 720. The permeate compartment 720 is below the feed compartment 700 in FIG. 7A, and for that reason, it is not visible in FIG. 7A. The feed compartment 700 has an input 704, for receiving the feed flow, and an output 706, at which the feed flow is discharged from the feed compartment. The feed compartment 700 sandwiches together with the permeate compartment 720, which is shown in FIG. 7B, the membrane 600. The feed compartment 700, the permeate compartment 720, and the membrane 600 form an MD module 730.

The heating element 610 is not in direct contact with the membrane 600 in this embodiment. In fact, FIG. 7B shows the predetermined distance D between the membrane 600 and the heating element 610. The heating element 610 is attached to a back wall 702A of the feed compartment 700, by any known means. FIG. 7B shows the contact points 612 and 614 of the heating element 610 being attached to the feed compartment wall 702A. FIG. 7B also shows the feed flow 708 and the permeate flow 722. The permeate compartment 720 has a housing 721 having an inlet 724 and an outlet 726 through which the permeate flow enters and exits the module, respectively. In this embodiment, the permeate flow travels in an opposite direction relative to the feed flow, as illustrated by the arrows in FIG. 7B.

The localized heating discussed in the embodiments illustrated in FIGS. 3A, 3B, 6, 7A and 7B supplies the heat energy directly to the membrane-liquid interface maintaining a stable temperature regime across the membrane. As a result, the evaporation process can be augmented at the membrane surface. The concept of localized heating can be realized through the self-heating membranes. Some groups have attempted to develop such membranes using photo-thermal materials which can convert light energy into heat using the thermo-plasmonic effect [1-5]. The Joule heating phenomenon, in which the kinetic energy of the electrons is converted into thermal energy upon passing an electrical current [6-9] is another example for supplying energy to the membrane's surface. The group in [9] investigated localized heating in MD processes using Joule heating of a carbon nanotube composite MD membrane. The group in [10] studied the concept of localized heating of a hollow fiber membrane in a sweeping gas MD. In a more recent approach, the group in [7] demonstrated localized heating with radio frequency based induction coupling, where the energy was transferred remotely through an induction heating power supply.

The concept of self-heating membranes has obtained improved flux results; however, all such approaches are based on manipulating the membrane surface properties. The membrane surface properties (such as wettability and adhesiveness) are crucial in ensuring the membrane functionality in MD. In addition, the stability of the coating material used by these attempts may degrade, leading to a decrease in the water flux and overall system performance, especially for larger scale applications. However, no studies have been proposed localized heating that does not affect the membrane surface properties. In the embodiments discussed herein, the heat energy is generated either inside the membrane, or just outside of the membrane, close to the feed membrane-liquid interface, using the electric heating layer. No modification of the membrane's surface is necessary, i.e., no nanoparticles need to be incorporated. By delivering the heat locally, a stable temperature regime can be maintained without manipulating the membrane's surface properties. As the heating layer only heats a thin layer of the feed flow at the membrane-liquid interface, the TP effect will decrease and hence the water vapor flux will increase, leading to a decrease in the specific energy consumption (improved gain output ratio, GOR) compared to the conventional bulk feed water heating.

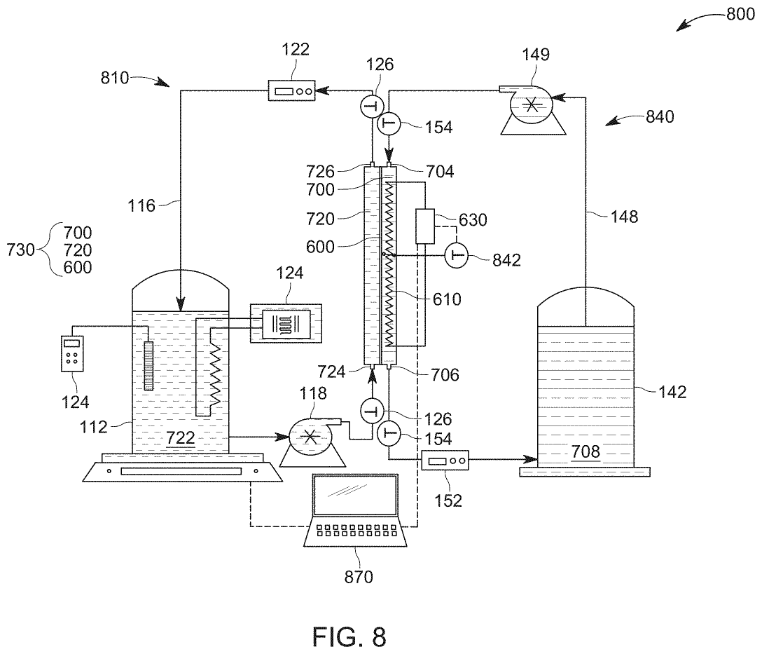

The feed compartment 700, the membrane 600, and the permeate compartment 720 may be used in an MD system 800 as illustrated in FIG. 8. The MD system 800 has many common elements with the MD system 100, and the description of those common elements is not repeated herein. The MD system 800 has the permeate part 810 and the feed part 840. The feed part 840 has no external heater attached to the feed tank 142 for heating the feed fluid 708. This is different from the traditional MD system 100, which uses the external heater 146 for heating the entire feed fluid 144 prior to delivering it to the MD module 730. By removing the external heater 146, the energy losses associated with this heater and also the thermal energy losses along the piping system 148 are eliminated.

The heating layer 610 of the feed compartment 700 takes over the role of the external heater 146, and thus the heating layer 610 would directly heat the feed fluid 708 that is present inside the feed compartment 700. The power source 630 provides the necessary electrical energy to the heating layer 610 for heating the feed fluid 708. Because of this localized heating, no heat is lost at the feed tank 142 and/or along the piping system 148 when transporting the feed fluid 708, contrary to the traditional systems 100. A temperature sensor 842 may be provided inside or on the feed compartment 700 to monitor the temperature of the feed flow 708 next to the membrane 600. In one application, the temperature sensor 842 is placed between the membrane 600 and the heating layer 610, as illustrated in FIG. 8. The output of the temperature sensor 842 is provided to the computing system 870, which, based on an internal algorithm programmed as desired, determines when to switch on and off the control of the power source 630 to maintain the temperature of the feed fluid 708, next to the membrane 600, in a desired temperature range, for example, between 60 and 65 degrees C. Any other range may be selected in the computing system 870.

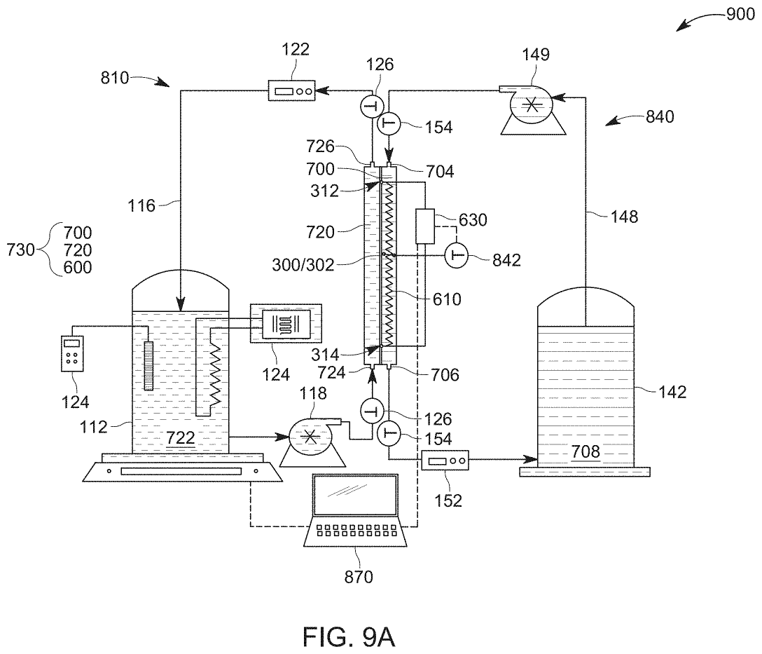

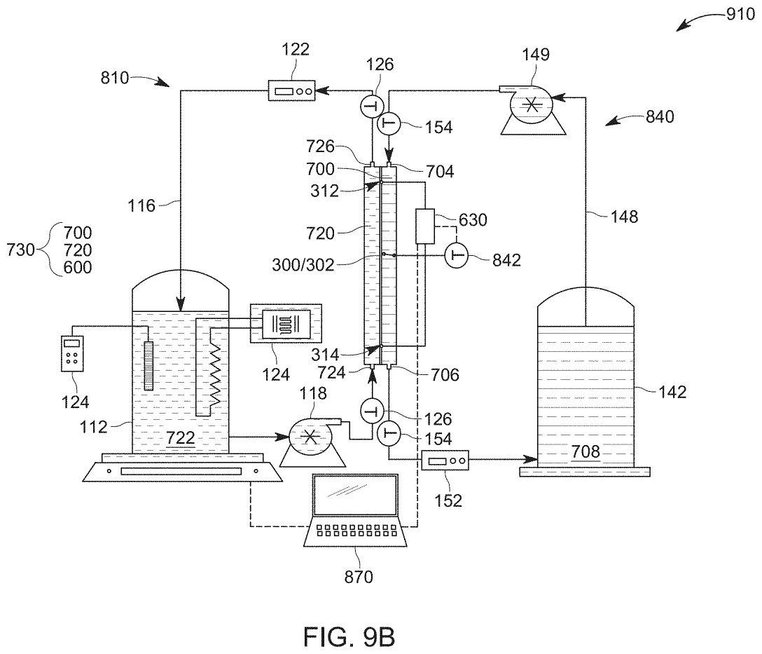

While the heat is generated in the embodiment illustrated in FIG. 8 by the heating layer 610, which is placed in the feed compartment 700, and the heating layer 610 is placed at the desired distance D away from the membrane 600, in another embodiment, it is possible to use the membrane 300 or 302 instead of, or in addition to the membrane 600, as shown in FIGS. 9A and 9B. more specifically, the system 900 in FIG. 9A uses the membrane 300 or 302, with the heating layer 310 provided inside the membrane (as shown in FIG. 3A) or as a support for the membrane (as shown in FIG. 3B), and with the additional external heating layer 610 provided away from the membrane. Both heating layers 310 and 610 can be connected to the power source 630. In one application, it is possible that each heating layer is connected to its own power source. The system 910 in FIG. 9B does not use the external heating layer 610, but only the internal heating layer 310. In this case, the internal heating layer 310 is connected to the power source 630.

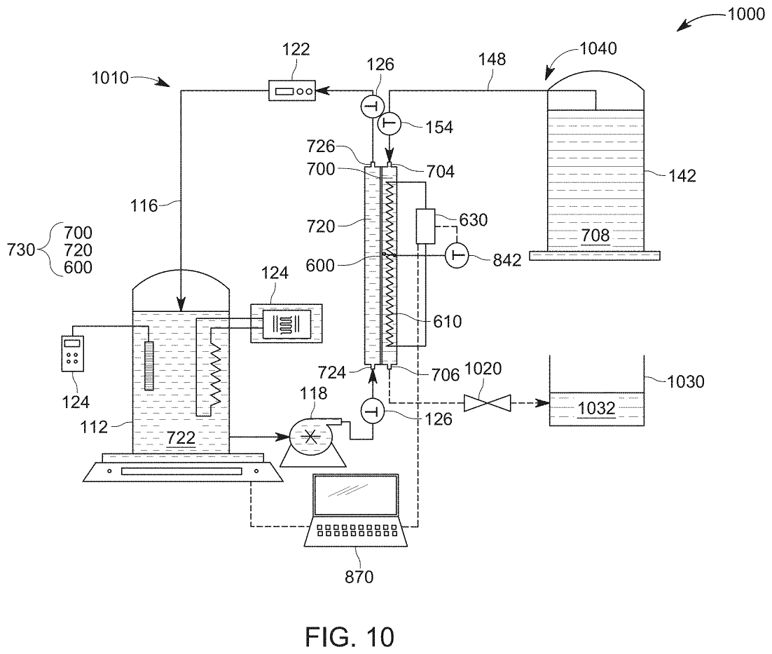

The inventors have discovered that instead of using the direct contact membrane distillation (DCMD) setup shown in FIG. 8, a modified setup, as shown in FIG. 10, further improves the efficiency of the MD system. Note that this novel system can work only with the heating layer 610, or only with the heating layer 310, or with both heating layers. The new configuration illustrated in FIG. 10 is called a dead-end DCMD configuration (because it have zero feed circulation) and this new configuration can be combined with any of the localized heating illustrated in the embodiments of FIGS. 3A, 3B, 6, 7A, and 7B, which would allow to further eliminate circulation heat loses, which cannot be realized in the conventional MD systems due to the rapid temperature stratification. The system's overall performance has significantly improved with the energy efficacy approaching the thermodynamic minimum energy requirement for water evaporation as now discussed.

The system 1000 does not recirculate the feed flow 708 from the feed tank 142, after passing the feed compartment 700, back to the feed tank 142, as illustrated in FIG. 8, but rather collects the processed feed flow 1032 (also called waste) into a waste tank 1030. The feed tank 142 is placed to be gravitationally above the MD module 730 so that the feed fluid 708 enters into the feed compartment of MD module 730 only due to the gravity, without external help, i.e., a pump. This means that the pump 149 is not necessary in this embodiment. After the feed fluid 708 fills the feed compartment 700, the heating layer 610 or 310 or both, depending on the membrane used (FIG. 10 shows the use of the membrane 600, but as previously discussed, it is also possible to use the membrane 300 or 302 instead of the membrane 600), is turned on, the feed fluid is heated to the desired temperature, and the permeate 722 is removed from the permeate compartment 720 to the corresponding permeate tank 112. After a given time, for example, 30 minutes, a flush valve 1020, which fluidly connects the output 706 of the feed compartment 700 to the waste tank 1030, is instructed by the computing system 870 to open, the waste feed 1032 is removed from the feed compartment 700, a new feed fluid 708 enters and fills up the feed compartment 700, the flush valve 1020 is closed, and the desalinization process starts again.

The system 1000 can be programmed with the computing system 870 to introduce an additional processing step, that was found by the inventors to be even more advantageous, as discussed later. For this modified process, after the feed fluid 708 have been processed in the feed compartment 700, the flush valve 1020 is instructed to open to remove the processed feed 1032 to the waste tank 1030. However, the flush valve 1020 now stays open for a longer time to allow the feed flow 708 to wash out or clean the surface of the membrane 600 from the salt accumulated there. In other words, while in the first configuration of the system 1000, the processed feed 1032 from the feed compartment 700 is simply replaced with fresh feed fluid 708, as the computing system 870 times the valve 1020 to allow only the volume of fluid occupying the feed compartment to exit the compartment into the waste tank 1030, in this modified configuration, the computing system extends that time so that unprocessed feed fluid 708 washes out the surface of the membrane 600 and goes into the waste tank 1030 without being processed. The amount of feed fluid 708 used to wash the surface of the membrane is selected as desired by the operator of the system. In addition, the frequency of flushing out the feed compartment is also selected by the operator of the system, and can be as often as the operator desires, e.g., 30 minutes. In this way, the membrane 600 is cleaned between two consecutive distillation steps.

Three-dimensional (3-D) numerical calculations were simultaneously performed for each tested MD configuration (100, 800, and 1000 with and without flushing) to estimate the heat transfer mechanism and the associated permeate flux enhancement. For these tests, a nichrome heating coil was used as the heating element for the configurations 800 and 1000, and the coil was placed in a circular shaped MD flow cell setup similar to the setup shown in FIG. 7B. Experiments were performed on the different MD configurations discussed above in order to compare the performance parameters between the conventional bulk heating and the localized heating.

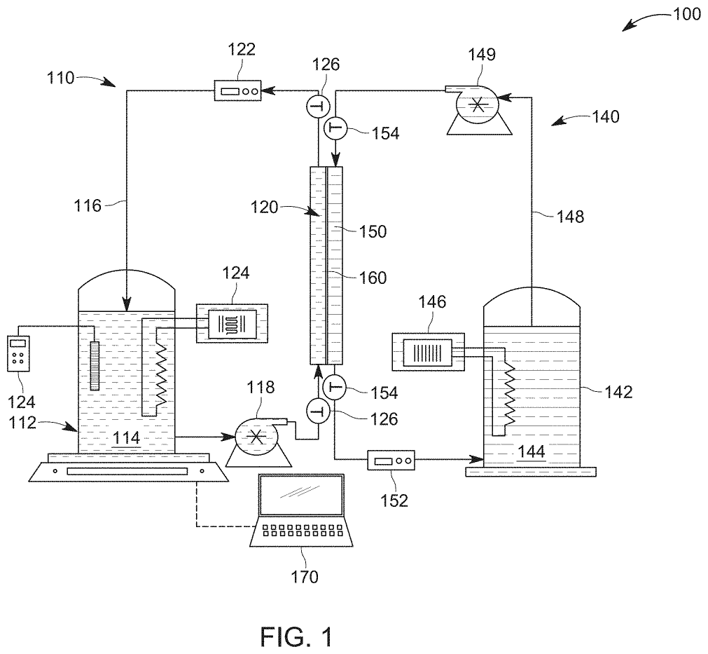

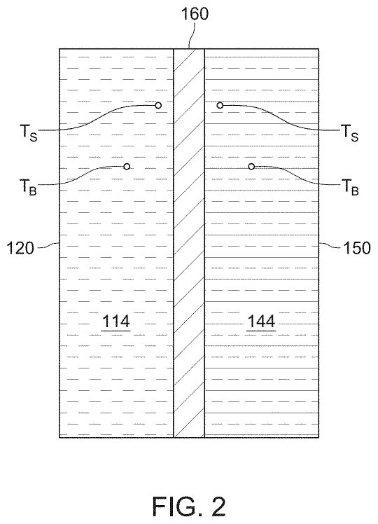

Four different configurations were tested using a large membrane surface area: (1) conventional DCMD system 100 with bulk heating (BH) as illustrated in FIG. 1, (2) localized heating cross-flow (LHCF) system 800 as shown in FIG. 8, in which the heating is applied only inside the feed channel of the feed compartment and the feed fluid is circulating in the same manner as in the conventional DCMD system 100, (3) a localized heating dead-end (LHDE) system 1000 with no feed circulation, as shown in FIG. 10, and (4) localized heating dead-end system 1000 with intermittent feed channel flush (LHIF configuration).

For the experiments performed with these configurations, Red Sea water (conductivity: 58 mS/cm) without any pretreatment was used as the feed fluid 708 and RO water (conductivity: 0.015 mS/cm) was used as the permeate flow 722. The DCMD process was conducted in a counter-current mode, and the feed and permeate fluids were supplied to the MD module from the corresponding feed and permeate tanks by using pumps with the flow rates of 300 mL/min and 280 mL/min, respectively. The feed flow rate was set to 20 mL/min more than the permeate flow to compensate for the flow effect of the pump assembly at elevated temperatures. The cooling and heating were achieved by circulation bathes. The feed and permeate fluid temperatures were set at 60° C. and 25° C., respectively. The inlet and outlet temperatures of the feed and permeate fluids were measured by 10K thermistors and recorded by the computing device 870. An additional 10K thermistor was used as a feedback control to maintain a stable feed water temperature of 60° C.

An acrylic MD module with the active membrane area of 0.0213 m² (165 mm diameter) was fabricated by the inventors as shown in FIGS. 7A and 7B. The module consisted of two circular compartments to accommodate the feed and permeate fluids. A heating coil was implanted at the feed side of the module adjacent to the membrane surface. A hydrophobic polytetrafluoroethylene (PTFE) membrane was used and this membrane has an average pore size of 0.22 μm and 85% porosity.

The energy utilization was calculated in two ways: a) using an energy meter, and b) by applying the first law of thermodynamics using the temperature and flow values. Qᵢₙ (kVV) is the total heat energy supplied to the MD system, as calculated from the energy meter reading. The total heat energy content of the feed water was utilized for three main processes: circulation, conduction and evaporation. The circulation heat Q_{cr} (kVV) is the heat dissipated during the feed circulation process, which is the case only for the bulk heating configuration, i.e., system 100. The circulation heat is calculated from the temperature and flow values by subtracting it from the total heat content, Qᵢₙ:

Q_{cr}=Qᵢₙ−(\dot{m}_{f}*Cₚ*ΔT), (1)

where \dot{m}_{f} is the mass flow rate of the feed water (kg/s), Cₚ is the specific heat energy of the water (4.2 kJ/kgK), and ΔT is the difference between the initial and final feed temperatures.

The heat distribution inside the MD module is made up of the heat transfer by conduction and heat transfer by evaporation. The heat transfer by evaporation (Qₑᵥ, kW) was calculated according to the following equation:

Qₑᵥ=\dot{m}_{d}*h_{fg} (2)

where \dot{m}_{d} is the mass flow rate (kg/s) of the water vapor across the membrane, and h_{fg} is the enthalpy of the water vaporization (kJ/kgK).

The heat transfer by conduction (Q_{cd}, kW) was calculated as follows:

Q_{cd}=(\dot{m}_{f}*Cₚ*ΔT)−Qₑᵥ. (3)

The specific energy consumption (SEC, kWh/m³) is the energy consumed per 1 m³ of water production, and was calculated by using the following relation:

$$SEC = \frac{{Q}_{in}}{{m}_{d}} , \qquad ( 4 )$$

where Qᵢₙ (kW) is the total electric heat energy supplied to the system, and mₐ is the mass of the distillate (kg).

The gain output ratio (GOR) represents the efficiency of a thermal desalination system. It is the ratio of the distillate water produced with the particular energy input. It is calculated using the following relation:

$$GOR = \frac{{m}_{d} * {h}_{fg}}{{Q}_{in}} , \qquad ( 5 )$$

where h_{fg} is the enthalpy of the vaporization heat of the water (kJ/kgK), m_{d} is the mass of the distillate (kg/s), and Qᵢₙ is the energy input.

The permeate flux J (kg/m² h) was calculated as follows:

$$J = \frac{{m}_{d}}{A * Δ t} , \qquad ( 6 )$$

where m_{d} is the mass of the distillate permeate water (kg), A is the membrane's active surface area (m²), and Δt is the MD time (h).

For the localized heating cross-flow configurations shown in FIGS. 8 to 9B, the feed water was heated by the build-in heating coil embedded next to the membrane surface as discussed above. The feed and permeate flow rates and temperatures were the same as in the bulk heating configuration. In the localized heating dead-end configuration (see FIG. 10), the feed water was fed by gravity from a feed tank, which was positioned above the MD module and heated by a heating coil inside the feed compartment. The localized heating dead-end with intermittent flush configuration was similar to that of the localized heating dead-end except that the feed water inside the feed compartment was flushed out with a new portion of the feed water at a given time interval, for example, every 30 minutes. All the MD experiments were conducted based on a 1 kWh of energy input (the same energy consumption), which was measured by an energy meter.

A conductivity meter 124 was used to monitor the permeate 722's conductivity to ensure the membrane's integrity during the MD runs. The permeate's conductivity was below 15 μS/cm during all experiments. To investigate the heating effect on a surface of a polymeric membrane, plural membranes were placed inside a corresponding module and heated locally to 60° C. The membranes were extracted and subjected to a range of surface characterization techniques to ensure no surface damage or loss in hydrophobicity occurred after the localized heating process. A scanning electron microscopy (SEM) was employed to observe the changes in the membrane's morphology. The samples were coated by a 4 nm iridium layer, and SEM imaging was performed at an acceleration voltage of 5 kV. A Fourier transform infrared (FT-IR) spectrometer with an attenuated total reflectance (ATR) attachment in a scanning range of 500 cm⁻¹-4000 cm⁻¹ was utilized to investigate the functional groups present on the membrane surfaces before and after the localized heating. The membrane hydrophobicity was determined by measuring the surface contact angles using a drop-shape analyzer.

A numerical model was utilized to predict the mass transport through the tested MD configurations. At the pore level, the mass transport through the membrane is primarily determined by the ratio of the mean free path of the water vapor molecules to the membrane pore diameter (Dₚ), referred to as the Knudsen number (Kₙ):

$${K}_{n} = \frac{λ}{{D}_{p}} . \qquad ( 7 )$$

The water vapor mean free path (λ) can be determined as:

$$λ = \frac{{k}_{B} {T}_{m}}{√ 2 {P}_{m} {σ}_{v}^{2}} , \qquad ( 8 )$$

where k_{B} is the Boltzmann constant (1.38·10⁻²³ J/K), Pₘ is the mean average pressure in the membrane pores (Pa), Tₘ is the membrane surface's temperature, and σ is the water vapor collision diameter (0.2641 nm).

Depending on the value of Kₙ, three possible mass transfer modes exist as follows: (a) Knudsen diffusion (Kₙ>1) in which the molecular collisions with the walls dominate as compared to the gas-gas collisions, (b) Molecular diffusion (Kₙ<0.01) in which the frequency of the gas molecule collisions is much higher than those with the pore walls, and (c) Knudsen-Molecular diffusion (0.01<Kₙ<1) in which the frequency of the molecular collisions with the pore walls is similar to that of the gas-gas collisions (often referred to as “transitional regime”). Based on the membrane pore diameter, the Knudsen number was calculated to be Kₙ≈0.5. It implies that for the membrane used in the experiments, the mass transport mode is primarily determined by the Knudsen-molecular diffusion theory.

According to the Knudsen-Molecular diffusion theory, the flux of an ideal gas through a pore is directly proportional to that of the pressure difference according to the following equation:

J=Cₘ*(P_{m,f}−P_{m,p}), (9)

where Cₘ is the mass transfer coefficient (Lm⁻² s⁻¹ Pa⁻¹), and P_{m,f} and P_{m,p} are the vapor pressures (Pa) of the feed and permeate on the membrane surface, respectively. The vapor pressure Pᵥ (Pa) was calculated using Antoine's Equation for a given membrane surface temperature, Tₘ (K), as follows:

$${P}_{v} = Exp [ 23.19 - ( \frac{3816.44}{{T}_{m} - 46.13} ) ] . \qquad ( 10 )$$

The mass transfer coefficient, Cₘ, was determined according to the kinetic theory to be:

$${C}_{m} = {[ {\{ \frac{ε {D}_{p}}{3 δ χ} \sqrt{\frac{8 M}{Π RT}} \}}^{- 1} + {\{ \frac{ε}{χ δ} \frac{DM}{RT} \frac{{P}_{T}}{{P}_{a}} \}}^{- 1} ]}^{- 1} , \qquad ( 11 )$$

where M, χ, ε, Dₚ, δ, D, P_{T}, Pₐ, R and T are the molecular weight of the water molecule (kg/mole), membrane tortuosity, membrane porosity, pore radius (m), membrane thickness (m), water-air diffusion coefficient, average air pressure (Pa), total pressure (Pa), ideal gas constant (J/mole·K), and mean temperature (K), respectively.

In order to predict the membrane surface temperatures (Tₘ) on the feed and permeate sides, a conjugate heat transfer calculation coupled with the Navier-Stokes equation was performed on the exact replicate of the MD module and the system configurations which were used for these experiments. The computations were simultaneously coupled in the fluid domains (feed and permeate channels) with solid domain (membrane) by appropriate boundary conditions.

At each time-step, the conservation equations (3-dimensional mass, momentum and energy equations) were solved using the conjugate heat transfer formulation (see for example [11]). The spatial temperature distribution, flow velocity and pressure distribution were determined on each discretized control volume (total ˜30 million volumes) in all computation domains (feed, permeate and membrane). The surface temperature profiles were extracted to compute the vapor pressures as given by the empirical Antoine equation (see Eq. (10)). Based on the pressure difference, the permeate flux J (see Eq. (9)) at each time was computed using the Knudsen-molecular diffusion theory.

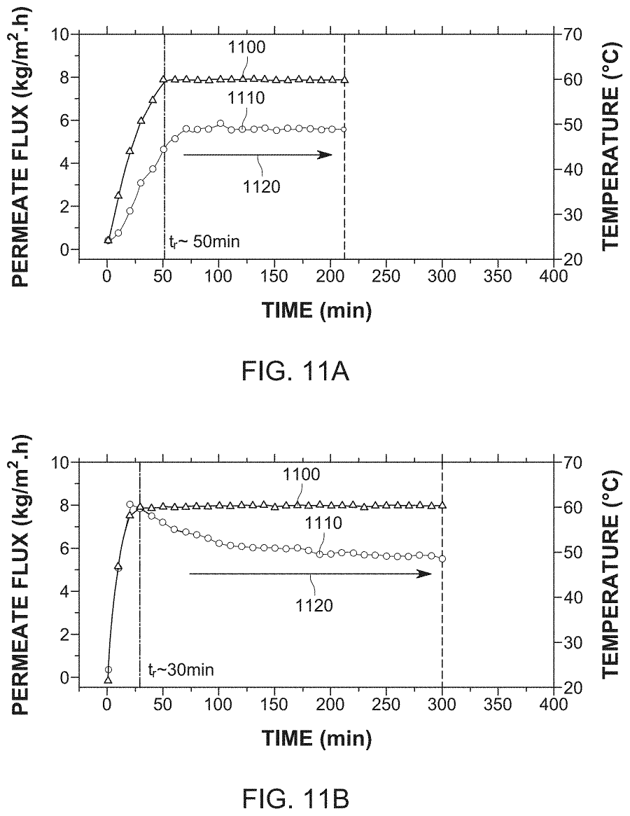

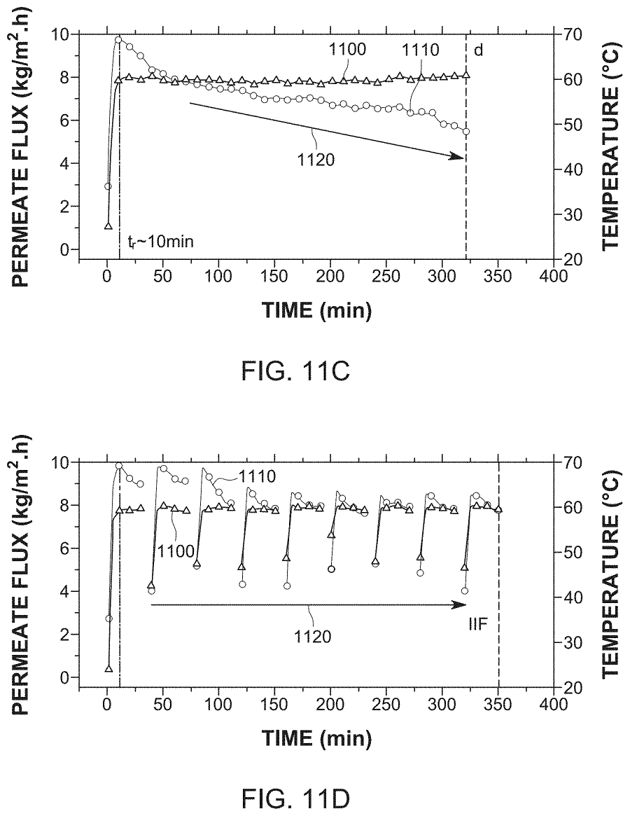

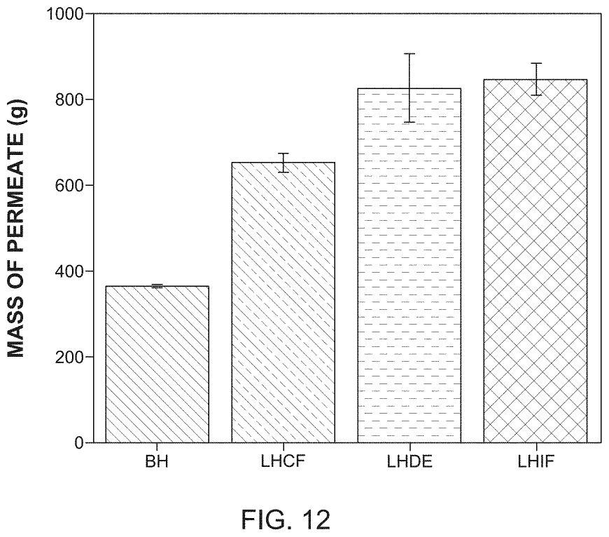

FIGS. 11A to 11D show the permeate fluxes and feed temperatures inside the MD module achieved for the different MD configurations considered (system 100, 800, 1000 without flushing, and 1000 with flushing) as a function of the process time at a total energy input of 1 kWh. When the MD system 100 was operated in the bulk heating mode, as illustrated in FIG. 11A, it took approximately 50 min for the feed temperature 1100 to reach its set point of 60° C. The permeate flux 1110 gradually increased until it reached a steady-state value of 5.6±0.3 kg/m² h. The mass of the produced permeate in this mode was 362±2 g, as illustrated in FIG. 12. This mode exhibits a steady state flux 1120.

When the process was run in the localized heating cross-flow mode (i.e., system 800), a significant improvement in the permeate flux 1110 was observed as noted in FIG. 11B. In this mode, the feed water was heated only inside the MD module so that the feed temperature reached its set point (60° C.) around 1.7 times faster as compared to that of a bulk heating mode. A 10.5% increase in the permeate flux was observed once the feed temperature 1100 reached its set point (60° C.) due to the diminishing TP upon the localized heating. Therefore, the elimination of the TP and the circulation heat losses leads to longer MD duration per 1 kWh of input energy. Consequently, the permeate production 1110 was increased by almost 80%, reaching 650±22 g, as illustrated in FIG. 12. This mode exhibited an improved stated state flux 1120.

The localized heating dead-end mode for the system 1000, when run without flushing, exhibited significantly better MD performance than the localized heating cross-flow system 800, reaching the set feed temperature 1100 five times faster as compared with the bulk heating, as shown in FIG. 11C. This was accompanied by an additional 20% increase in the permeate flux 1110, from 6±0.1 kg/m² h to 7.2±1.3 kg/m² h once the feed water temperature reached 60° C. Under this condition, a substantially enhanced permeate production of 825±81 g was observed, as shown in FIG. 12. This mode exhibited a flux decline trend 1120 due to the fouling of the membrane.

However, when the MD system 800 was operated in the localized heating cross-flow mode, the permeate flux 1120 decreased with the increase in the process time, as shown in FIG. 11B. This phenomenon was more pronounced in the case of the localized heating dead-end configuration shown in FIG. 11C as compared to that of the localized heating cross-flow configuration. Although the MD process is the least affected by the feed water salinity as compared to other membrane desalination processes, a continuous permeate flux 1120 decrease was observed in the localized heating dead-end mode during the entire MD operation due to the accumulation of the feed water constituents at the membrane surface. The localized heating dead-end could promote membrane fouling due to the rapid development of the concentration boundary layer, which may cause the accumulation of foulants near the membrane surface, hence reducing the mass and heat transfers across the membrane.

To address this issue, the system 1000 was also run in the “intermittent flush” configuration (localized heating dead-end with intermittent flush), in which the feed water inside the MD module is flushed at a predetermined time interval, e.g., 30 minutes, so that the accumulated fouling is washed away from the membrane surface and normal MD operation is then resumed. As a result, a maximum permeate flux 1120 of 9.8±1.6 kg/m² h (see FIG. 11D), corresponding to a mass of produced permeate water per 1 kWh of 845±38 g (see FIG. 12) was observed. The application of the intermittent flush allowed a more stable permeate flux 1110, which gradually reached its steady-state after the fourth flush cycle (see FIG. 11D). As a result, the permeate flux 1110 at the end of this process was higher than that achieved with the localized heating dead-end configuration in FIG. 11C. This mode exhibited a steady state flux 1120 that recovered due to the intermittent flush. Thus, it is expected that the combined effect of the localized heating and the intermittent flush of the system 1000 will enable more sustainable MD performance during the long-term operations, by maintaining a more stable permeate flux while alleviating the membrane fouling.

Three-dimensional simulations were conducted to describe the localized heating for the various MD configurations discussed above and to expose the effect of the hydrodynamic conditions on the heat transfer process prevailing in each MD configuration. To allow for the comparison of the experimental and modelling results, all flow and geometric conditions as well as membrane properties were assumed similar to those utilized in the experimental MD runs. The localized heating dead-end with intermittent flush configuration was not simulated, as the flushing part requires a concentration polarization model to be implemented in the numerical framework, which was beyond the scope of this investigation. Nevertheless, for the first cycle of a localized heating dead-end with intermittent flush mode (system 1000), the hydrodynamics and thermal conditions inside the MD module are expected to be the same as for the localized heating dead-end configuration with no flushing.

Based on the determined hydrodynamic conditions and corresponding thermal snapshots inside the feed channels, when the feed temperature inside the feed channel reached its set point of 60° C., the stream traces inside the MD module were calculated and they were overlapped with the velocity magnitude. For the bulk heating and localized heating cross-flow configurations, the feed and permeate flow rates were kept the same as in the experimental runs. The only difference was that in the bulk heating mode, the inlet feed water temperature was set to 60° C. and the heating element was not powered, while in the localized heating mode the feed entered at 24° C. (ambient temperature), with the powered element turned on to provide the thermal heat flux of 14,000 W/m² locally, near the membrane surface. For these two cases, the hydrodynamics (stream traces and velocity magnitudes) conditions were found to be similar. As the feed fluid entered the MD module, it traveled straight until the fluid encountered the central region with no heating coil filaments. Due to this design of the heating element, two vortices were trapped in the center of the heating coil and divided the whole incoming flow into the two sections. The recirculating region swept the majority of the module, with the low velocity having an epicenter at the center of the coil. Ahead of this recirculation region, the flow converged and exited out of the MD module. The highest velocity magnitude was observed in the middle region of the MD module. In general, a relatively low velocity magnitude of ˜0.01 m/s inside the feed channel was observed, with a narrow region in the center, achieving higher velocity magnitude in a range of ˜0.06 to 0.07 m/s. Since there is no inlet velocity in the case of the localized heating dead-end mode, the flow field evolution inside the feed channel was solely driven by the thermal convection which was generated by the heating coil. Consequently, the fluid movement was scattered, resulting in a significantly low-velocity magnitude (of about 0.001 m/s).

A thermal snapshot through the MD module was also determined. The thermal snapshot was extracted in the form of a spatial temperature distribution along a slice which was extracted from the top of the feed channel at a depth of 9 mm. This slice passed through the heating filament so that the associated thermal distribution and influence of the localized heating could be investigated. In the case of the bulk heating mode, the feed liquid was heated outside the MD module, as discussed above with regard to the system 100. Consequently, the highest temperature was observed in the central region of the MD module as the feed residence time in this region was shorter due to a higher fluid velocity, thereby allowing minimal heat dissipation. Contrarily, as indicated by the lower feed temperatures (less than the feed inlet temperature), more heat dissipation was observed in the low velocity regions with existed fluid recirculation.

In the case of the localized heating cross-flow (system 800), the spatial velocity and temperature distributions inside the module were completely reversed. As the incoming feed was not heated externally and the heating element was powered, the central region of the MD module had the lowest temperature (due to the design of the coil). Similar to the bulk heating mode, this effect was attributed to the higher feed flow velocity observed in this region, which did not allow enough residence time for the feed water to extract heat from the heating element. The low recirculating region, however, showed a significant increase in temperature with the maximum being in the range of 88° C.-96° C. due to a larger heat transfer caused by the increased fluid residence time. Furthermore, an asymmetry in the temperature distribution was observed in the left and right recirculating regions. For the localized heating dead-end case (system 1000), an effective uniform feed heating was achieved due to the no-flow condition. The feed in the vicinity of the heating coil was effectively heated and the void region of the coil (central region) had the lowest temperature.

The heat distribution inside the feed channel was primarily governed by the interaction between the heating coil and the incoming feed through the convection process. However, at the membrane surface, the evaporation and heat loss by conduction primarily resulted in the TP, which significantly altered the surface temperatures on the feed and permeate sides of the membrane. As known, the permeate flux which passes through the membrane pores, is solely dependent on the vapor pressure difference across the membrane. Therefore, the membrane surface temperature ultimately determines the performance of any MD configuration. To account for this effect, the spatial membrane surface temperatures were extracted and utilized to compute the vapor pressures using the Antione Equation (Eq. (10)). The permeate flux at each computational node on the surface was computed using the Knudsen-molecular diffusion.

The membrane surface temperatures at the feed and permeate sides, as well as the spatial fluxes, were calculated through the numerical model for the MD configurations of the 100, 800, and 1000 systems. For the case of the bulk heating (system 100), the central membrane region had the highest temperature of ˜60° C., whereas the majority of the other regions were characterized by lower temperatures in a range of 33° C.-45° C. The heat losses by conduction and evaporation were visible in the central region on the permeate side, where the permeate temperature increased locally. However, the highest permeate flux was still observed in the central region, which is attributed to the largest temperature gradient (corresponding to the highest vapor pressure difference) across the membrane surface.

Similarly, in the localized heating cross-flow configuration (powered heating element instead of fluid bulk heating, i.e., the system 800), lower temperatures on the feed side were observed in the central region on both the feed and permeate sides. Moreover, the high permeate flux region is interchanged, and higher local flux values were observed over a larger membrane surface area as compared to that of the bulk heating configuration.

The elevated permeate fluxes observed in the localized heating dead-end configuration of system 1000 were attributed to the more uniform heat transfer from the heating coil, which resulted in an increased feed water temperature (and corresponding temperature gradient) over a larger membrane surface area compared to the bulk heating configuration. As a result, the temperature gradient across the membrane and corresponding permeate fluxes were enhanced.

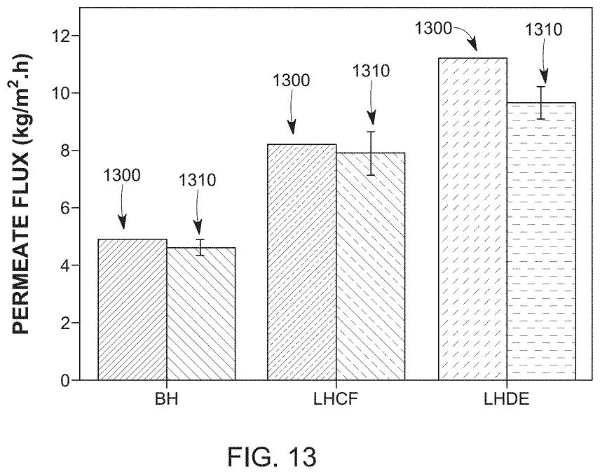

The spatial average values of the permeate fluxes over the membrane surface were further calculated and compared to those obtained during the actual MD experiments. As seen in FIG. 13, the spatial average permeate fluxes 1300 predicted by the model had values of 4.86 kg/m²·h, 8.43 kg/m²·h and 11.56 kg/m²·h for the bulk heating, localized heating cross-flow, and localized heating dead-end, respectively, which is well-correlated to the permeate fluxes 1310 achieved experimentally when the feed temperature reached its pre-set value of 60° C. The slight variation between the experimental and model results was attributed to the following factors. The heat loss to the ambient environment through the acrylic MD module could not be controlled, whereas, to simplify the simulations in the adiabatic conditions, no heat loss from the outer boundary was assumed. Further, possible membrane curvature inside the flow cell may also affect some heat transfer and channel hydrodynamic characteristics, which were ignored in the present simulations

An energy analysis of the MD process for the various configurations introduced above is now discussed. Because the MD is a thermally driven process, it requires a liquid-vapor phase change energy, called enthalpy of vaporization, which is two to three orders of magnitude higher than the Gibbs energy of separation required in the RO process, i.e., 650 kWh/m³ versus 0.76 kWh/m³ (0% recovery) in RO. Furthermore, the reported SEC and GOR values of the MD system are in a range of 1 kWh/m³-9,000 kWh/m³ and 0.1-5, respectively.

The total heat energy content of the feed flow is consumed through three main processes: circulation, conduction, and evaporation. The circulation heat exists only in the case of bulk heating, and it was calculated to be around 36±4% of the total heat input. The circulation heat treated as wasted heat does not contribute to the distillation process. Unlike the bulk heating, the localized heating mode has an incorporated electric heating coil and no circulation heat loss.

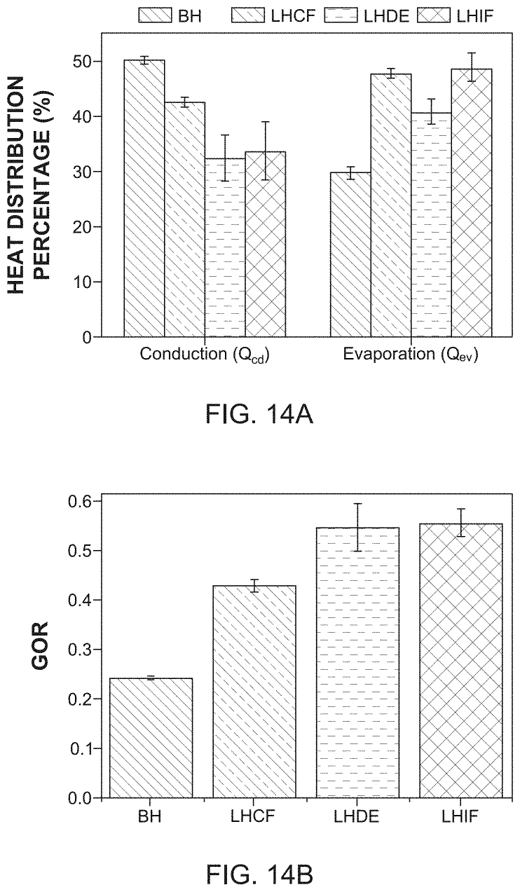

Because the localized heating cross-flow maintained a stable temperature across the membrane, the thermal boundary layer existed in its minimum form with the least TP. The total heat energy utilized in the evaporation Qₑᵥ and conduction Q_{cd} across the membrane were calculated using Eqs. (2) and (3) and are shown in FIG. 14A. The Q_{cd} dominates over the Qₑᵥ in the bulk heating, 50% and 29.6% respectively. It indicates the least amount of energy utilized in the distillation process. For the localized heating cross-flow, the evaporation heat increased to 47.7% as compared to the 29.6% in the bulk heating. It illustrates the decrease in the TP due to the inbuilt heating, which provides a stable temperature regime. Further, for the localized heating cross-flow and localized heating dead-end with intermittent flush, the conduction heat loss decreased to around 33.6%, mainly due to the absence of the feed circulation. However, the evaporation heat energy for the case of localized heating dead-end decreased from the localized heating cross-flow mode, mainly due to the effect of concentration accumulation after a certain time. A lower value of the heat required for evaporation could be attributed to the increased fouling accumulation at a membrane surface, which suppressed the vapor evaporation at a pore entrance.

The GOR values of the bulk heating and localized heating were calculated according to Eq. (5) and they are shown in FIG. 14B. The bulk heating has the lowest GOR of ˜0.24. The GOR increases with the localized heating, which showed a 78% increase for the localized heating cross-flow mode. The localized heating dead-end with intermittent flush showed the highest GOR value, ˜0.6. The significant increase in the GOR value for the localized heating is associated with the higher flux resulting from a decreased thermal boundary layer. Further, the absence of a feed-flow condition inside the MD module and corresponding increase in the evaporation allowed for a significant enhancement of the GOR values during the dead-end localized heating (124±21% and 132±12% increases for the localized heating dead-end and localized heating dead-end with intermittent flush modes, respectively).

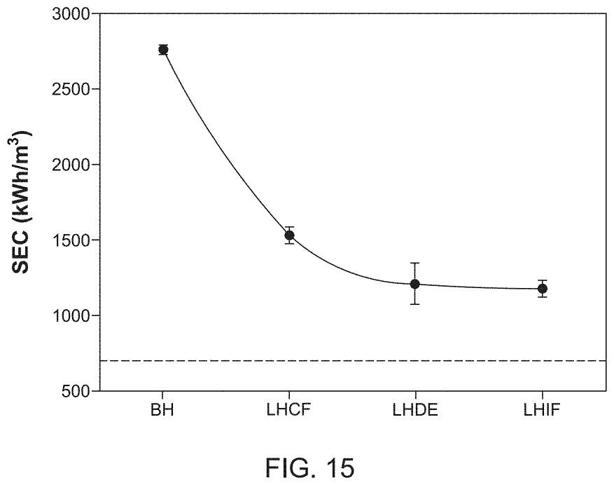

The SEC values for all four MD configurations were calculated according to Eq. (4) and are shown in FIG. 15. The bulk heating has the highest SEC value, around 2,762 kWh/m³±22 kWh/m³. The localized heating cross-flow showed around a 44% decrease in the SEC value as compared to the bulk heating. For the localized heating dead-end and the localized heating dead-end with intermittent flushing configurations (system 1000), the SEC further decreased and reached the lowest values of 1,183 kWh/m³ for the localized heating dead-end with the intermittent flush. This significant decrease in the SEC value is attributed to the increase in the permeate production resulting from the localized heating. This elevated permeate water flux was caused by a decrease in the TP and the increased evaporation during the localized heating. Also, a rapid increase of the feed water temperature to its set value of 60° C. enhanced the initial permeate flux and the total permeate production so that the SEC values were reduced to 1,213±139 kWh/m³ and 1,183±57 kWh/m³ for the localized heating dead-end and localized heating dead-end with intermittent flush, respectively. When comparing the calculated SEC values with the theoretical thermodynamic minimum energy of thermal evaporation required to evaporate 1 kg of water (650 kWh/m³, which is shown as a dashed line in FIG. 15), it is observed that the localized heating dead-end and localized heating dead-end with intermittent flush configurations were positioned almost twice as close to the thermodynamic minimum energy of the evaporation value when compared to that of the bulk heating mode. Moreover, the localized dead-end MD energy consumptions (4,258 kJ/kg) demonstrated herein, are significantly lower than those reported previously for the conventional MD systems (118,000 kJ/kg for the DCMD, 42,696 kJ/kg for the vacuum MD, and 82,800 kJ/kg for the air-gap MD). Therefore, a 44%-57% increase in the specific energy efficiency improvements was achieved for the localized heating modes (cross-flow and dead-end) due to the reduced TP and enhanced water evaporation on the membrane surface, as shown in FIG. 15.

The local heating effects on the membrane were also investigated. Given that the heating coil inside the MD module is located next to the membrane surface, it was investigated whether the localized heating would impose any adverse effects on the surface of the polymeric membrane. The changes in the membrane's integrity and morphology were evaluated by a range of surface characterization techniques, including SEM, ATR FT-IR, and contact angle measurements. A comparison of the SEM images of a virgin membrane with the membrane subjected to localized heating revealed no changes in the surface morphology after the surface heating so that both images exhibited typical node-like PTFE structures. This observation was further supported by the results of the ATR FT-IR spectroscopy, in which both membrane surfaces produced characteristic PTFE bands at 1204 cm⁻¹, 1150 cm⁻¹ and 637 cm⁻¹. These bands were ascribed to the asymmetrical stretching, symmetrical stretching and waggling of the CF₂ groups, respectively.

The contact angle measurements revealed no significant difference between the virgin and after surface heating surfaces (135.1°±2.8 and 131.2°±1.1, respectively). Thus, it was concluded that the localized heating did not compromise the membrane integrity, nor affect its morphological properties.

Therefore, based on the results discussed above, it is concludes that the dead-end MD system 1000 with localized heating outperformed all the other configurations in terms of vapor flux and energy consumption, mainly due to the minimization of the TP caused by the temperature stratification occurring in the conventional MD process. The introduction of the intermittent flush to the dead-end configuration further improved the MD performance by reducing the membrane fouling and associated heat losses. Modeling results revealed that localized heating provides more uniform heat transfer across the membrane due to increased feed water temperature over a larger membrane area. As a result, the TP across the membrane was mitigated and corresponding permeate fluxes were enhanced. The dead-end localized heating configuration showed:
10%-45% increase in the water vapor flux for the different configurations,
44%-57% decrease in the specific energy consumption for the cross-flow and dead-end modes, reaching 1183 kWh/m³ (dead-end), thus approaching the thermodynamic minimum energy limit for water evaporation (650 kWh/m³), and
increase of GOR values by 132±12%.

The surface characterization techniques confirmed no changes in membrane integrity and morphology after prolonged surface heating, which provides a promising new framework for sustainable MD development. Therefore, it is expected that the combined effect of the localized heating and the intermittent flush in dead-end mode to enable more sustainable MD for long-term operations by maintaining more stable vapor flux while alleviating membrane fouling and minimizing energy consumption.

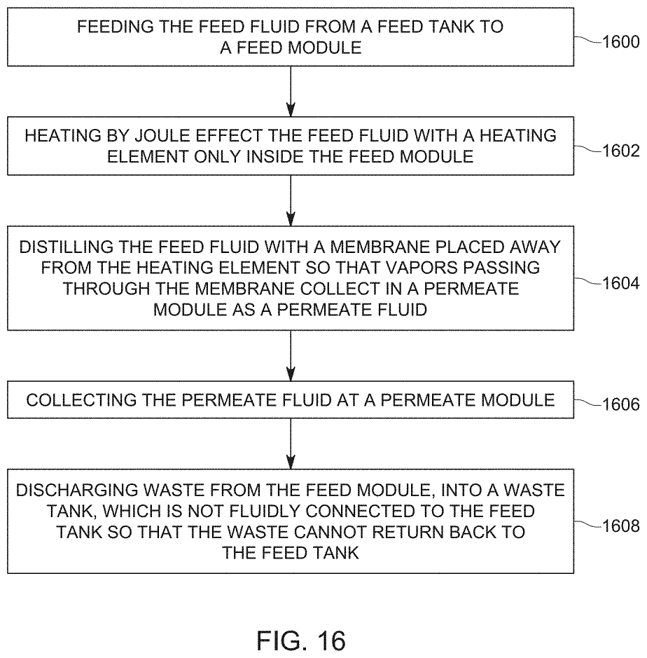

A method for producing distilled water from a feed fluid is now discussed with regard to FIG. 16. The method includes a step 1600 of feeding the feed fluid 708 from a feed tank 142 to a feed compartment 700, a step 1602 of heating by Joule effect the feed fluid 708 with a heating element 610, only inside the feed compartment 700, a step 1604 of distilling the feed fluid 708 with a membrane 600 placed away from the heating element 610 so that vapors passing through the membrane 600 collect in a permeate compartment 720 as a permeate fluid 722, a step 1606 of collecting the permeate fluid 722 at a permeate compartment 720, and a step 1608 of discharging waste 1032 from the feed compartment 700, into a waste tank 1030, which is not fluidly connected to the feed tank 142 so that the waste 1032 cannot return back to the feed tank 142. For this method, no external heater for heating the feed fluid 708 while inside the feed tank 142 is present.

The disclosed embodiments provide a dead-end membrane distillation system with localized interfacial heating for membrane distillation. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

[1] Politano A, Argurio P, Di Profio G, Sanna V, Cupolillo A, Chakraborty S, et al. Photothermal Membrane Distillation for Seawater Desalination. Advanced materials. 2017; 29.
[2] Dongare P D, Alabastri A, Pedersen S, Zodrow K R, Hogan N J, Neumann O, et al. Nanophotonics-enabled solar membrane distillation for off-grid water purification. Proc Natl Acad Sci USA. 2017; 114:6936-41.
[3] Tan Y Z, Wang H, Han L, Tanis-Kanbur M B, Pranav M V, Chew J W. Photothermal-enhanced and fouling-resistant membrane for solar-assisted membrane distillation. Journal of Membrane Science. 2018; 565:254-65.
[4] Wu X, Jiang Q, Ghim D, Singamaneni S, Jun Y-S. Localized heating with a photothermal polydopamine coating facilitates a novel membrane distillation process. Journal of Materials Chemistry A. 2018; 6:18799-807.
[5] Ye H, Li X, Deng L, Li P, Zhang T, Wang X, et al. Silver Nanoparticle-Enabled Photothermal Nanofibrous Membrane for Light-Driven Membrane Distillation. Industrial & Engineering Chemistry Research. 2019; 58:3269-81.
[6] Song L, Huang Q, Huang Y, Bi R, Xiao C. An electro-thermal braid-reinforced PVDF hollow fiber membrane for vacuum membrane distillation. Journal of Membrane Science. 2019; 591.
[7] Anvari A, Kekre K M, Azimi Yancheshme A, Yao Y, Ronen A. Membrane distillation of high salinity water by induction heated thermally conducting membranes. Journal of Membrane Science. 2019; 589.
[8] Boo C, Elimelech M. Thermal desalination membranes: Carbon nanotubes keep up the heat. Nature nanotechnology. 2017; 12:501-3.
[9] Dudchenko A V, Chen C, Cardenas A, Rolf J, Jassby D. Frequency-dependent stability of CNT Joule heaters in ionizable media and desalination processes. Nature nanotechnology. 2017; 12:557-63.
[10] Shukla S, Benes N E, Vankelecom I, Méricq J P, Belleville M P, Hengl N, et al. Sweep gas membrane distillation in a membrane contactor with metallic hollow-fibers. Journal of Membrane Science. 2015; 493:167-78.
[11] ANSYS. Release 19.0, ANSYS Fluent Theory Guide. ANSYS Inc; 2019.

1. A membrane for membrane distillation processing, the membrane comprising:
a heating element configured to generate heat when an electrical current is applied to the heating element;
a polymeric matrix having pores that allow a vapor to pass through, but not a liquid; and
electrical contacts electrically connected to the heating element,
wherein the entire heating element is covered by an insulating material to prevent the heating element to directly interact with the liquid processed by the membrane.

2. The membrane of claim 1, wherein the polymeric matrix includes first and second polymeric layers, and the entire heating element is sandwiched between the first and second layers.

3. The membrane of claim 1, wherein the heating element is attached only with one side to the polymeric matrix to provide physical support to the polymeric matrix, and another side of the heating element is coated with another insulating material.

4. The membrane of claim 1, further comprising:
a coating layer provided directly over the polymeric matrix,
wherein the coating layer is configured to transform light into electrical energy to heat the polymeric matrix.

5. The membrane of claim 4, wherein the coating layer includes nanostructures having dual conducive/photo-thermal properties.

6. A membrane distillation (MD) module for distillation, the MD module comprising:
a feed compartment configured to receive a feed fluid;
a membrane configured to allow a vapor of the feed fluid to pass through, but not a fluid of the feed fluid;
a permeate compartment configured to receive the vapor from the feed fluid and to generate a permeate fluid; and
a heating element located within the feed compartment, at a predetermined non-zero distance D from the membrane,
wherein the heating element is configured to heat the feed fluid to reduce a temperature difference between (1) a liquid-membrane interface formed between the membrane and the feed fluid, and (2) an interior of the feed compartment.

7. The MD module of claim 6, wherein the heating element includes a metallic wire covered with an insulator so that the metallic wire is not in direct contact with the feed fluid.

8. The MD module of claim 6, wherein the membrane includes an additional heating element that is fully insulated from the feed fluid and the permeate fluid.

9. A membrane distillation (MD) system for distillation, the MD system comprising:
an MD module configured to distillate a feed fluid;
a heating element provided inside the MD module and configured to heat the feed fluid by Joule effect;
a power source connected to the heating layer for providing an electrical current to the heating layer;
a feed tank configured to hold the feed fluid and to provide the feed fluid to the MD module; and
a permeate tank configured to hold a permeate fluid and to collect the permeate fluid from the MD module,
wherein there is no external heater for heating the feed fluid while inside the feed tanker.

10. The MD system of claim 9, further comprising:
a waste tank configured to receive a waste that remains after the feed fluid has been processed by the MD module; and
a valve fluidly placed between the MD module and the waste tank to control a flow of the waste from the MD module into the waste tank.

11. The MD system of claim 10, further comprising:
a computing system configured to control the valve so that only an amount of the feed fluid inside the feed compartment is allowed to enter the waste tank at a given time.

12. The MD system of claim 10, further comprising:
a computing system configured to control the valve so that an amount of the feed fluid larger than an amount of the feed fluid inside the feed compartment is allowed to enter the waste tank at a given time.

13. The MD system of claim 10, wherein there is no fluid communication between the feed tank and the waste tank.

14. The MD system of claim 10, wherein the feed tank is placed above the MD module, so that the feed fluid enters the MD module due exclusively to the gravity and the MD module is placed above the waste tank so that the waste enters the waste tank due exclusively to the gravity.

15. The MD system of claim 9, wherein the MD module comprises:
a feed compartment configured to receive the feed fluid;
a membrane configured to allow a vapor of the feed fluid to pass through, but not a fluid of the feed fluid; and
a permeate compartment configured to receive the vapor from the feed fluid and to generate the permeate fluid,
wherein the heating element is configured to heat the feed fluid to reduce a temperature difference between (1) a liquid-membrane interface formed between the membrane and the feed fluid, and (2) an interior of the feed compartment.

16. The MD system of claim 15, wherein the heating element is located within the feed compartment, at a predetermined, non-zero, distance D from the membrane.

17. The MD module of claim 15, wherein the membrane includes an additional heating element, located within the membrane, and the additional heating element is fully insulated from the feed fluid and the permeate fluid.

18. The MD system of claim 9, wherein the heating element includes a metallic wire covered with an insulator so that the metallic wire is not in direct contact with the feed fluid.

19. The MD system of claim 9, wherein a waste from the MD module is returned to the feed tank.

20. (canceled)
